(19) United States
(12) Patent Application Publication
(10) Pub. No.: US 2008/0242327 A1
(43) Pub. Date: Oct. 2, 2008

(54) SYSTEM AND METHOD FOR SENDING SMS AND TEXT MESSAGES

(76) Inventors: Manny M. Gabriel, Dededo, GU (US); Leandro M. Gabriel, Dededo, GU (US)

Correspondence Address: FELDMANGALE, P.A., ONE BISCAYNE TOWER , 30TH FLOOR , 2 SOUTH, BISCAYNE BOULEVARD, MIAMI, FL, 33131-4332, US

(21) Appl. No.: 12/058,376

(22) Filed: Mar. 28, 2008

Related U.S. Application Data
(63) Continuation-in-part of application No. 10/686,820, filed on Oct. 16, 2003, now Pat. No. 7,369,865.
(60) Provisional application No. 60/419,804, filed on Oct. 17, 2002.

(51) Int. Cl. H04Q 7/20

(52) U.S. Cl. 455/466

(57) ABSTRACT

A system for sending SMS messages from a cell phone on one cellular network to a cell phone on a different cellular network bypasses the Short Message Service Center (SMSC) established by network administrators to enable SMS messages to be sent to an SMS Network Boundary device where it is place on the Internet, routed to a management server where routing information is maintain and accessed, and forwarded to an SMS Network Boundary device on the recipient's cellular network for forwarding to the intended recipient. A personal computer can be substituted for one of the cell phones, and the system may be configured to send SMS messages as e-mail or using an HTML interface.

### CROSS REFERENCE TO RELATED APPLICATIONS AND CONTINUING DATA

This application claims priority from U.S. Provisional Patent Application No. 60/419,804, filed in the United States Patent and Trademark Office on Oct. 17, 2002, and entitled System and Method for Sending SMS and Text Messages. This application is a continuation in part of, and claims priority from U.S. Application Ser. No. 60/686,820, filed on Oct. 16, 2003, and entitled System and Method for Sending SMS and Text Messages.

### FIELD OF INVENTION

The present invention relates generally to wireless communications. More particularly, the present invention discloses a system and method for sending Short Message Service (SMS) messages from one cellular network to another cellular network or to or from a cellular network to a computer connected to the Internet.

### BACKGROUND OF THE INVENTION

Wireless and other communication networks are well known and much has been written about them. The organization of such networks into cells is also well known. Text messaging or Short Message Service is provided by the operators of such wireless communication networks, where such networks have the capability of supporting such messaging. Short Message Services, or more simply put “SMS”, enables a user to send messages to and receive text messages from other users of a similar communications (cellular) network. The SMS function attempts to deliver a message to a cellular telephone whenever the cellular telephone is registered to the network, even when the terminal is engaged in a voice or data call.

The cellular telephone may also roam throughout the network and still be capable of sending and receiving messages. A cellular telephone configured for SMS provides methods for the user to receive, read, write/edit, clear, send, and save messages.

While SMS is convenient for users communicating within the same network, a user wishing to communicate a text message to a person in a different network often experiences problems. Most cellular networks handle SMS messages through a Short Message Service Center (SMSC), which serves the primary function of storing and forwarding SMS messages to users of the network. The SMSC also performs a gatekeeping function of sending and receiving SMS messages to and from other networks. This function, however, is subject to control by the service provider, who may or may not cooperate or coordinate with the SMSCs on other networks, thus raising questions of reliability and timeliness of SMS message delivery to recipients in other cellular networks. These problems are not necessarily limited to the sender's and receiver's respective carriers deciding not to cooperate and thus not allow the transmission of SMS messages between the networks, but may be of a technical nature, such as incompatible digital standards or protocol. The problem of incompatible networks is even more apparent when trying to send messages to a user in a country different from that of the sender. Even when communications between networks is possible, the messages are sent through a network bridge connected to the SMSC, and some service providers assign a low priority to SMS messages leaving or entering the network. This can result in a significant time delay between the message being sent and the message being received. Thus there is a need for a method that allows users to send SMS messages between incompatible and distant cellular networks.

### SUMMARY OF THE INVENTION

The invention is a system for and a method of sending SMS messages between cellular networks and other wireless communication networks via the Internet. As used herein, the term cellular shall be construed to include other types of wireless communication, and the use of the term wireless shall be construed to include cellular communication as well. Additionally, as used herein the term SMS message and the term message shall be construed to mean text messages of the type that are supported by the short message services offered by cellular communication providers.

The system disclosed herein is comprised of a number of physical components and appropriate software. The physical components of the system of the invention include the SMS user devices, SMS network boundary devices (“SNB devices”), management servers, and personal computers. The SNB devices and the management server are programmed to function according to an iterative decision making methodology.

The SMS user device is used to initiate and/or terminate SMS messages from within a cellular network. The user device generally will be a cellular telephone capable of sending and receiving SMS messages, although new technology may incorporate SMS capability into other devices that communicate using cellular networks. The invention also includes an embodiment whereby SMS messages can be initiated and received either as email or in a Hyper Text Markup Language (HTML) based interface by a personal computer connected to the Internet. SMS user devices are connected to the system through the cellular telephone network.

The SMS network boundary (“SNB”) device combines the functionality of an SMS cellular receiver/transmitter with a computer connected to the Internet, and is registered as a device on a cellular network. The computer component of an SNB device is connected to the Internet via standard TCP/IP connection means. An SNB device may be connected or configured in a number of ways, such as connecting the computer component to the cellular network using modems or other suitable interfaces, rather than cellular phones. Similarly, communications between the cellular device and the computer may be made over wireless links such as Bluetooth or infrared.

SNB devices may consist of a single computer that incorporates a number of internet network interfaces, each having a discrete IP address, and further having a registered cellular receiver/transmitter associated with each network interface. In this manner, multiple SNB devices may be incorporated within a single physical device. SMS messages received from the cellular network may be converted by the SNB device into messages to be sent over the Internet, and messages received from the Internet may be converted and transmitted into the cellular network as SMS messages. SNB devices may be as simple as a cellular telephone connected to a networked computer, or may be a single fully integrated device combining the requisite functions. SNB devices are located in a plurality of cellular networks, and are used to forward SMS messages from cellular networks to a management server or to receive messages from the management server and forward them to the cellular network.

The SNB device may also incorporate a gateway function. The gateway function is employed when messages originating from a registered user's cellular telephone will be received by another cellular telephone on a different cellular network. The gateway function provides the management server with information concerning the routing of the message and enables a reply message to be routed back to the registered user who originated the initial message.

The management servers are computers connected to the Internet for worldwide access. They may be physically located anywhere having Internet access, and may even be physically incorporated within an SNB device. In this configuration, the management server may process messages between remote cellular networks, and may also process SMS messages originating from or destined to the cellular network of which the SNB device is a part. Management servers are programmed to complete a variety of tasks, including routing SMS messages to desired recipients, providing email and HTML based interfaces with a user's computer, providing a link between wireless communications carriers' SMSCs and the system of this invention, and tracking users' account information. Management services need not be located in any specific network, and one management server can be used to pass SMS messages between a plurality of networks.

The system may also include personal computers connected directly to the internet. These personal computers may be configured to send and receive SMS messages in any of the formats previously disclosed, or using formats yet to be developed. As components in the system of this invention, they offer the same advantages of communicating through SMS messages sent to or received from a cellular device, but provide the convenience, efficiency, and associated functionality and security of a personal computer.

A user desiring to send a message to a person in a different network can key in his or her text message and send that message to an SNB device in his or her network. The cellular receiver on the SNB device receives the message and sends it to the computer, which then forwards the message to the management server. The management server forwards the message to an SNB device in the recipient's network, and the message is forwarded to the recipient via the cellular transmitter of the SNB device on the recipient's cellular network.

The system disclosed herein includes a number of algorithms that reside in various physical components of the system through the use of software, hardware, or firmware. These programs enable the physical components of the system to send, receive, and forward messages.

The system disclosed herein enables a person to send and receive messages from a cellular telephone to or from any computer anywhere worldwide. Additionally, the system disclosed herein allows users to send messages to distant networks without concern that the message will be given a low priority for transmission over a network bridge.

This system allows users to send SMS/text messages to recipients in other cellular telephone networks without using the SMSC network bridges established by the user's cellular provider. Messages sent using the system disclosed herein can be sent from cellular telephones or computers, and they can be received on cellular telephones or computers. A user sending or receiving a message on a computer can use either an email program or an HTML based interface. This system is advantageous to users communicating to recipients in distant networks because the user will not have worry about his or her text message being assigned a low priority by his or her cellular provider.

It is an object of this invention to provide a system that will allow users to send SMS messages between wireless communication networks over the Internet.

It is also an object of this invention to provide a system wherein a user can send an SMS message using a cellular telephone, and the recipient can retrieve the message using a personal computer.

It is a further object of this invention to provide a system wherein a user can send an SMS message using a personal computer, and the recipient can receive the message on a cellular telephone.

It is another object of this invention to provide a system in which the functions of a management server or of multiple SNB devices may be combined within a single physical hardware device.

### BRIEF DESCRIPTION OF THE DRAWINGS

The several objectives and features of the present invention will become more readily apparent from the following detailed description taken in conjunction with the accompanying drawings in which:

FIG. 1a shows the routing path for an SMS message sent between two countries using methods that are currently available.

FIG. 1b shows the routing path for an SMS message sent between two countries using the system and method disclosed herein.

FIG. 2 is a block diagram showing an embodiment of the algorithm for sending or retrieving messages on an SNB device, according to the invention.

FIG. 3 is a block diagram showing an embodiment of the algorithm on a user's computer in accordance with the invention.

FIG. 4 is a block diagram showing an embodiment of the algorithm for a management server in accordance with the invention.

FIG. 5 is a block diagram showing an embodiment of the algorithm for the SNB device for routing an SMS message, according to the invention.

FIG. 6 is a block diagram showing an embodiment of the algorithm for the gateway operation of the SNB device according to the disclosure herein.

FIG. 7 is a block diagram showing the operational algorithm for a bridging program according to the disclosure herein.

FIG. 8 is a block diagram showing the operational algorithm for a program that allows clients to send and retrieve messages using an HTML based interface, according to the disclosure herein.

FIGS. 9a-9c show examples of virtual routing diagrams according to the current invention.

FIG. 10 is a block diagram showing the operational algorithm for a program that allows clients to send and retrieve messages via the client's email account according to the disclosure herein.

### DETAILED DESCRIPTION OF THE INVENTION

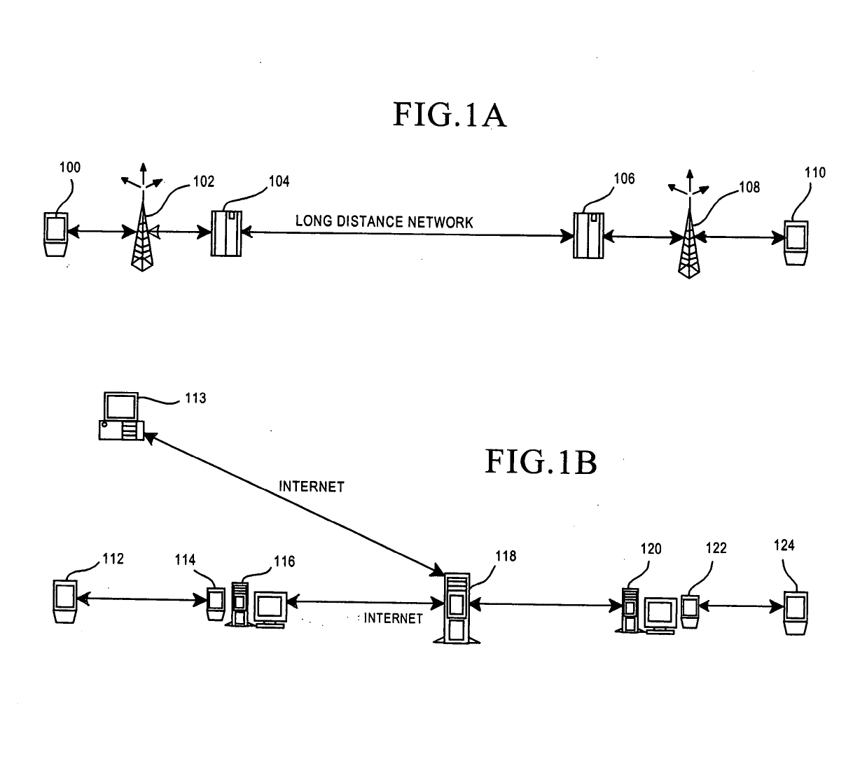

Turning now to the drawings, the invention will be described in preferred embodiments by reference to the numerals of the drawing figures wherein like numbers indicate like parts. According to the current technology shown in FIG. 1a, an SMS message sent between cellular networks in two separate countries must first go through the local wireless network provider 104 of the sender's network, over the long distance Public Switch Telephone Network, and through the wireless network provider 106 of the recipients network before reaching the recipient. This can cause great delays in the recipient getting the message because service providers often assign low priority to inter-carrier SMS messages, and consequently send them during periods of off peak use.

The physical components of the system disclosed herein can be seen in FIG. 1b. According to the invention, a person desiring to send an SMS message to a receiver in a different network sends the message to an SNB device, which may be a cellular telephone 114 and a computer 116, situated in his or her network. The SNB device receives the message via the cellular telephone 114 and sends the message over the Internet via a server/router 118 to an SNB device in the desired user's network/country. The message is then sent to the user through the SNB device, which is also a cellular telephone 122 and a computer 120 and wherein the telephone 122 is a part of the receiver's network.

Also shown in FIG. 1b, the current invention will allow a user to send text messages to a cellular telephone from a personal computer 113 via the Internet and to receive text messages from a cellular telephone on a personal computer. When using the personal computer option, a user can send and receive messages as an email or using an HTML based interface. In one embodiment of the invention disclosed herein, when a user desires to use the system of the current invention, he or she must first set up an account. Accounts can be set up on the Internet by accessing a web page of a service provider using the system disclosed herein, or by contacting the customer service representatives of such providers. When the user sets up an account, he or she provides the telephone number of his or her cellular telephone that will be used to send SMS messages, and the telephone numbers of the people that will be receiving messages. The user will then assign a recipient identification code to each intended recipient. The recipient identification codes will be programmed into a data file in the management server and will thereafter be used for routing SMS messages. Additional recipients may be added by accessing the provider through the Internet or contacting the customer service representative. Users can also set up their accounts to send and receive messages on the user's computer.

One method for debiting users of the current invention is the use of prepaid calling cards, having a finite value. Each card has a unique identification code assigned to it, and that code or personal identification number (PIN) is programmed into the management server. When a person desiring to send a text message, connects to the SNB device in his or her network, he or she sends the identification code assigned to his or her card as part of the SMS message. After ensuring that the intended recipient has received the message, the management server deducts the cost for sending the SMS message. The first time a user sends a message after purchasing a prepaid card, he or she enters the PIN. The PIN saved in a user data file and the value of the card is credited to that users account. Credit is deducted from the account every time a message is sent successfully. Other billing methods can also be used, such as assigning individual users a unique identification code and sending bills to users based on the number and length of messages sent during a pre-specified period of time or pre-purchasing credits for sending SMS messages. According to the disclosure herein an SMS message that originates from a sender's telephone 112 is routed to the telephone 114 that is part of the SNB device. The telephone is connected to the computer 116 using commercially available data cables and software drivers, and the computer is connected to the Internet using standard connection means. Together, the telephone and the computer make up the SNB device. The SNB devices are located within the cellular networks.

The SNB device receives messages from a telephone in the cellular network and sends the messages and the client information to the management server 118, which then sends the message to a SNB device in the desired receiver's network.

The SNB device also checks for messages from the management server that may be addressed to the cellular network in which the SNB device is located. If there are incoming messages for recipients in the cellular network where the SNB device is located, the SNB device will forward the message to the recipient's cellular telephone. If the recipient is located outside of his or her home network, and there is a SNB device in the network where the recipient is located, the message will be routed to the device in the network where the recipient is located. There are multiple SNB devices located in each cellular network to establish a method of virtual routing so that a single SNB device can be used to provide a service to multiple users.

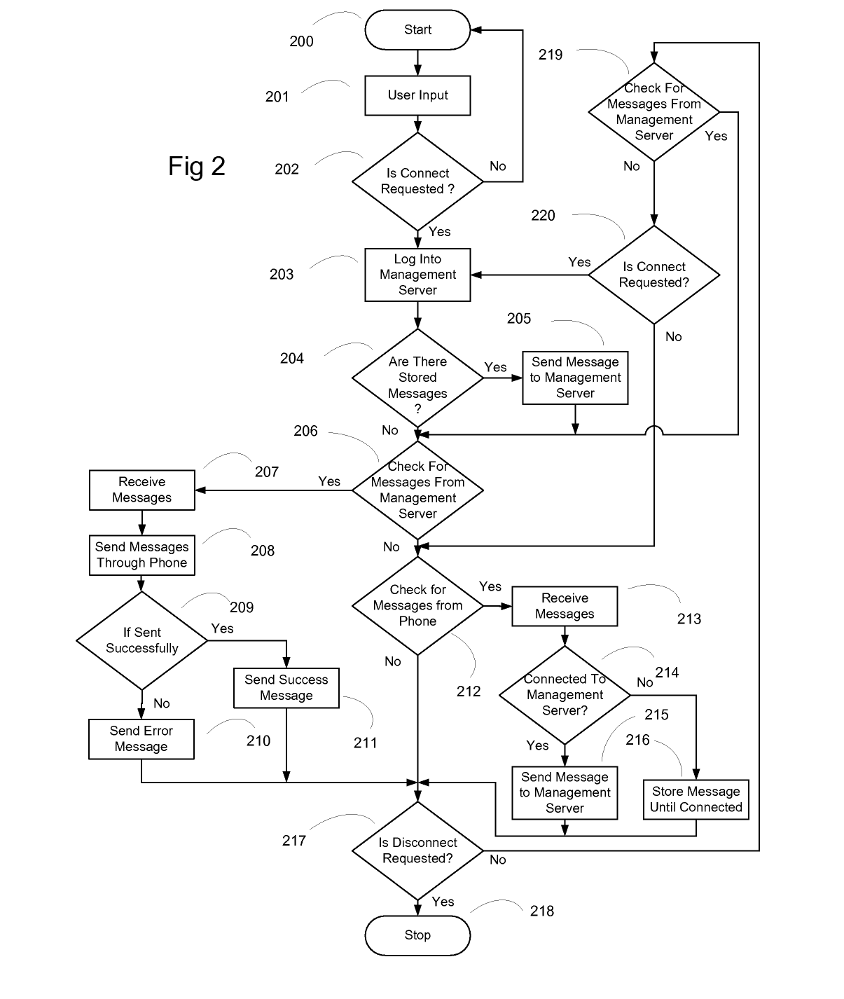

A basic function of the SMS transmitter/receiver component of the SNB device is message forwarding. The SMS transmitter/receiver can receive SMS messages from cellular telephones and forward them to the SNB computer, and can receive messages from the SNB computer and forward them to the cellular network. Messages forwarded to the cellular network can have originated from any type of user device. Referring to FIG. 2, the SMS transmitter/receiver will use the algorithm depicted in the flow chart. Where there is an SNB device in both the sending and receiving networks, each device will be programmed to use the same event-driven algorithm for message forwarding operations.

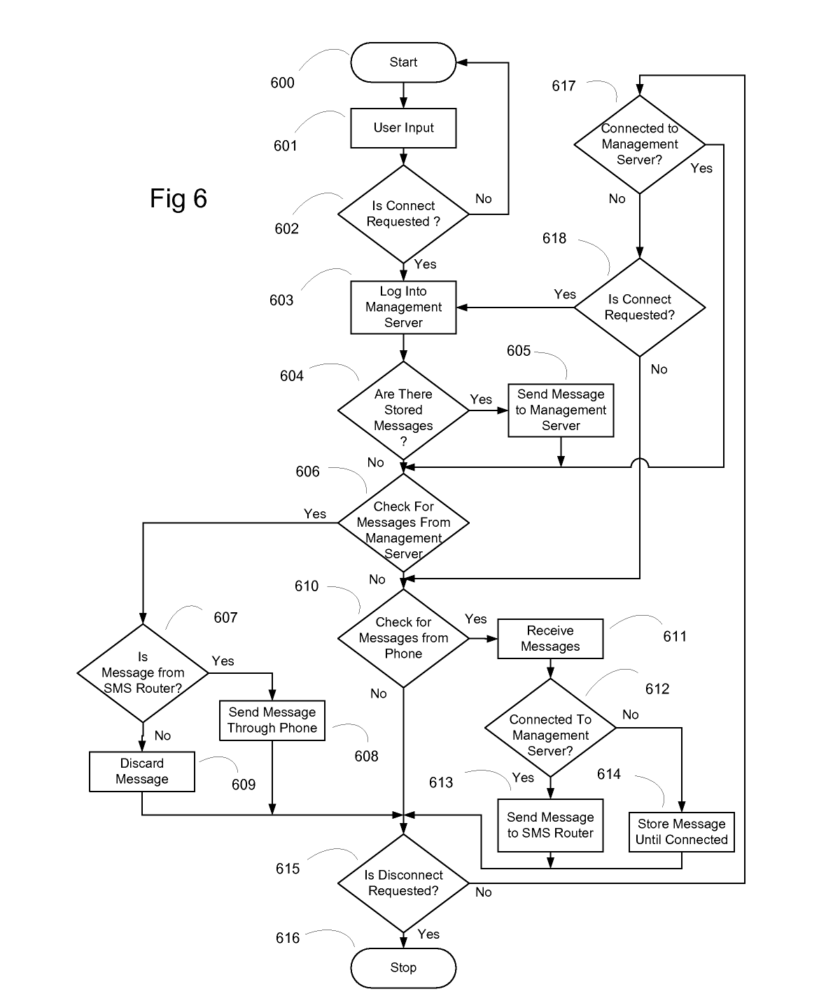

Another function of the SNB device is to act as a gateway that is capable of routing phone to phone SMS messages from a registered user of the system to a recipient on the same or another cellular network. By using a gateway, user account information is provided to the management server to ensure that a reply is properly routed back to the sender. The gateway function is in addition to the basic SMS forwarding function, which forwards messages without including account information. Referring to FIG. 6, the gateways are programmed to use the event-driven algorithm depicted therein.

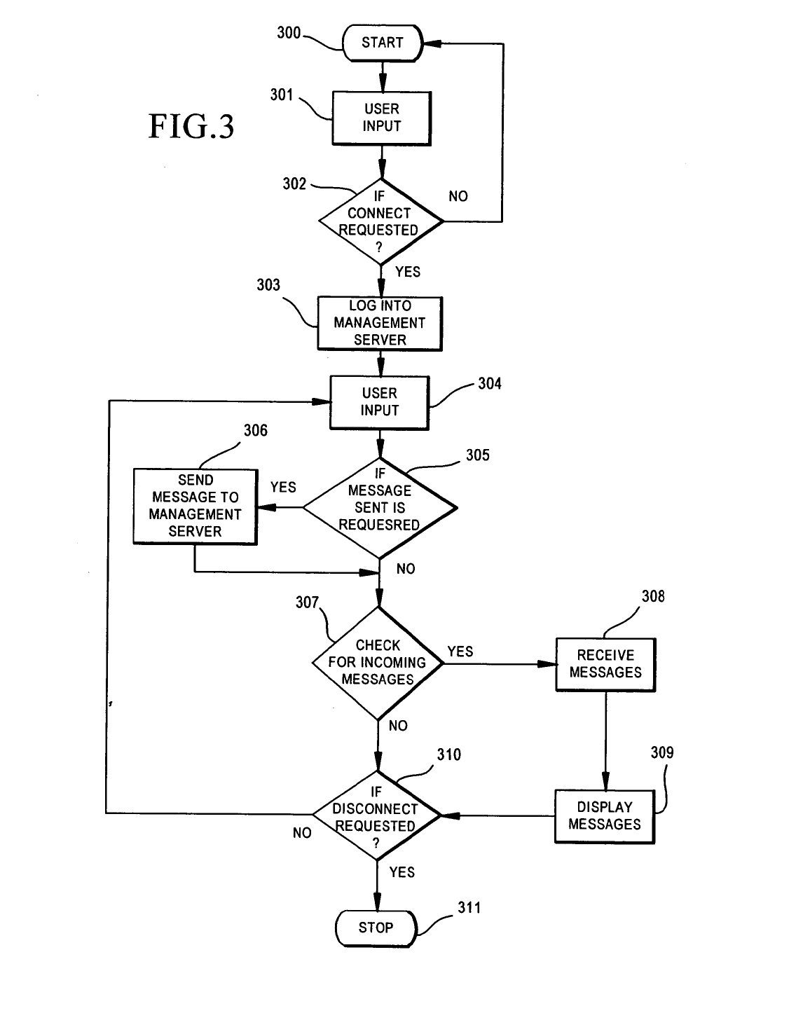

The system disclosed herein allows text messages to be sent and received on a user's computer via email or an HTML based interface. These messages can be sent from the computer to the intended recipient's cellular telephone, or sent from a cellular telephone and reviewed on a computer. The user's computer is programmed to use an event-driven algorithm (“Web SMS user”) which is depicted in FIG. 3.

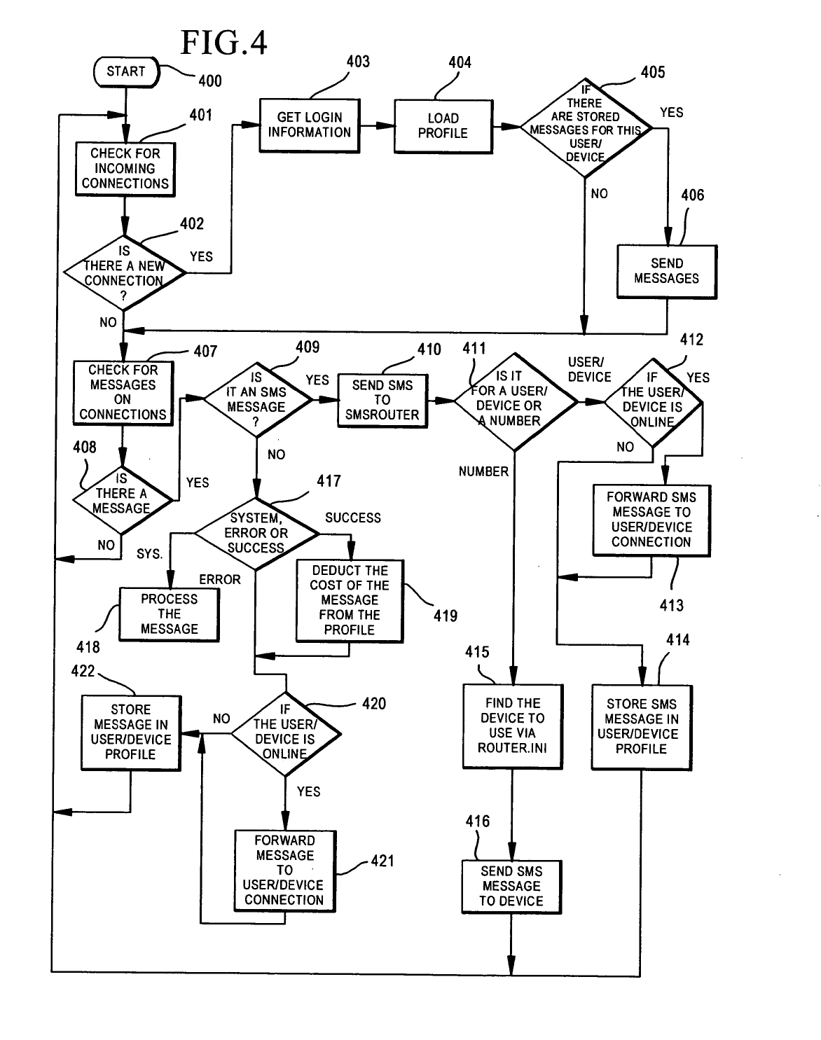

As shown in FIG. 4, the management server routes messages from the SNB device in the sender's network to the SNB device in the receiver's network and, if desired, to a user's personal computer. The management server also maintains the account information for each registered client, such as credit and message storage. Messages can be sent through the SNB devices in the client's cellular network to the management server and then to clients via a user's personal computer or through the SNB devices in remote cellular/SMS phones of non-clients. Non-clients can also send return messages to current clients. Once a client sends a message to a non-client, a route is established through one of the SNB devices in the recipient's network. Subsequently non-clients are then able to send a reply back to the registered client through that particular SNB device.

While one management server is capable of supporting communications between numerous networks, it is not envisioned that the number of servers be limited to one. Instead, the number of servers used for the system will be based on the number of people who use the system, the anticipated traffic load on the system, and the desired performance level of the system. Management servers are programmed to perform a number of tasks, but the main program for operation of the management server is shown below as “Management Server.”

The management servers can also be programmed to establish virtual routing with use of the route.ini file. The route.ini file contains the country codes and area codes for networks containing SNB devices, and other routing information for future messaging. In a preferred embodiment, when a first sender sends a message to a first recipient, the management server will remember the first recipient's number by creating a record and storing it in the route.ini file, cross referenced with the SNB device on the first recipient's network that will deliver the message. The route.ini file will also cross reference that record with an identifier identifying the first sender. When the first recipient replies to the first sender, the route.ini file will locate the record containing the first recipient's number and the SNB device used for the original message, and from that information can locate the SMS device and number of the first sender who will now receive the reply to the original message.

In the preferred embodiment, all routing information is based on identification of the user and the SNB device. In this embodiment, it does not matter whether the message is PC originated or phone originated. The route.ini file also allows non-clients to reply to text messages from a client through the same SNB device in the non-client's cellular network that forwarded the initial message to the non-client.

The route.ini file also contains information on the cellular phone networks served by each SNB device. When a message is sent to a non-client's telephone, the management server will access the route.ini file to determine which SNB device, to forward the message to. The route.ini file is a data file that follows a standard initialization file format. It is used to allow the application to assign a virtual route to a user. Virtual routing allows the management server to assign one SNB device phone to many users, instead of having to assign one number to one user.

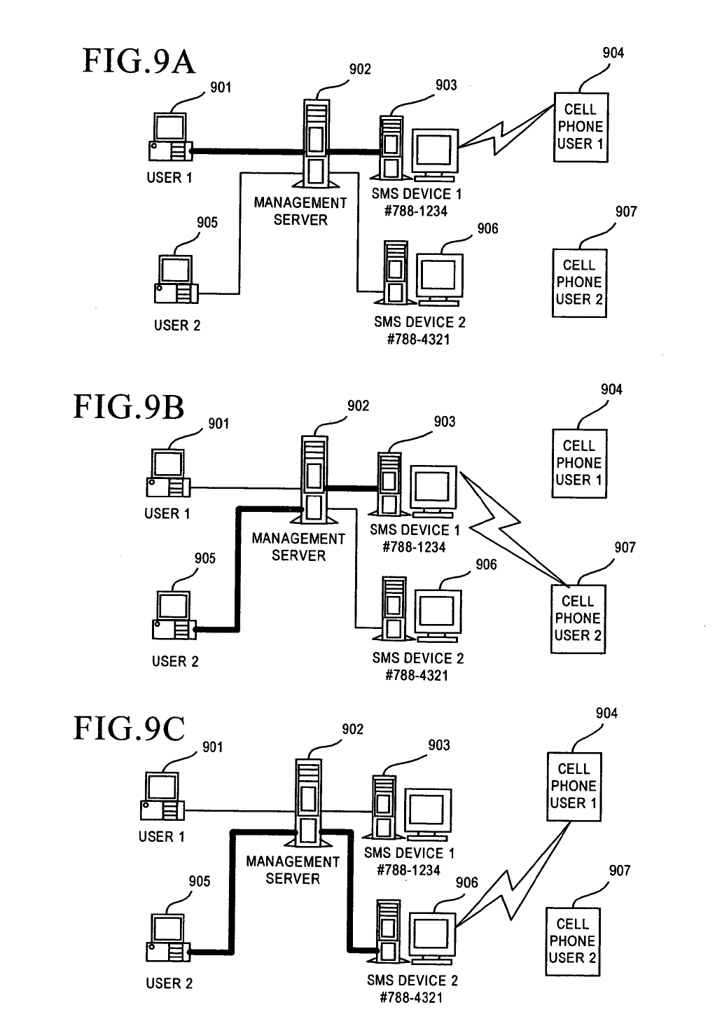

One embodiment of virtual routing is depicted in FIGS. 9a through 9c. In FIG. 9a, when user 1 (first sender) 901 sends a message to cell phone user 1 (first recipient) 904, the management server 902 uses virtual routing to establish a route for the message to take. In this case SNB device 1 (903) will forward the message to first recipient 904. Subsequently when cell phone user 1 (first recipient) sends a reply message to SNB device 1, the route.ini file will provide information so that the message will be routed back to user 1 (first sender).

In FIG. 9b, the same thing happens when user 2 (second sender) 906 sends a message to cell phone user 2 (second recipient) 907. A virtual route is established from second sender 906 to second recipient 907 through SNB device 1. When cell phone user 2 (second recipient) sends a message to SNB device 1, the message will be sent to back to user 2 (second sender). This method of virtual routing establishes a single SNB device that provides a service to multiple users.

Referring now to FIG. 9c, when user 2 (second sender) sends a message to cell phone user 1 (first recipient), a route is established through SNB device 2 (906) since user 1 (first sender) has already established the route to cell phone user 1 (first recipient) through SNB device 1. Thus when cell phone user 1 (first recipient) responds to SNB device 2, the message will be routed to user 2 (second sender).

While FIGS. 9a-9c illustrate virtual routing using SNB devices, this type of routing is also used for gateway devices in which a registered user sends SMS messages from a cell phone.

The management server also performs several other functions and is therefore loaded with several other programs. These programs include a routing program, a bridging program, a program that allows a client to send and retrieve messages on his or her computer using an HTML based interface, and a program that allows clients to send and retrieve messages using email.

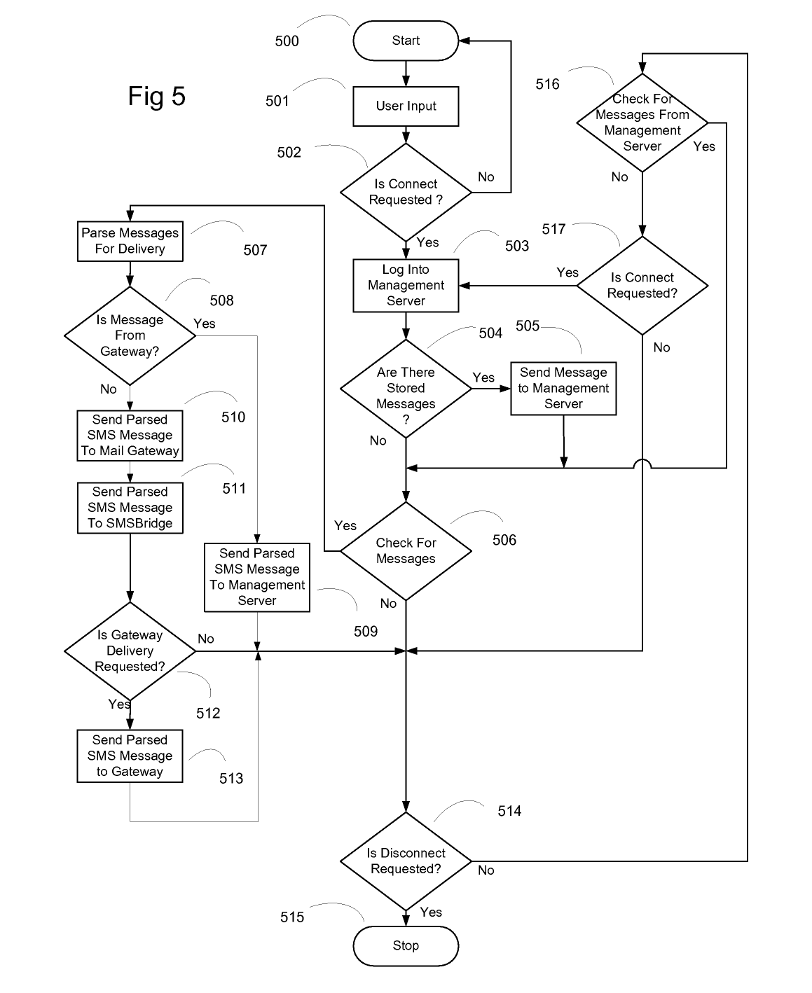

The routing program is depicted in FIG. 5, and adds routing capabilities for interfacing with other technologies and email. It also serves as the primary avenue for routing phone-to-phone SMS messages. All messages that the management server receives are sent to the routing program. The routing program then forwards the messages based on the configuration of the user's account. The routing program is referred to as “SMSrouter,” and operates according to an event driven algorithm.

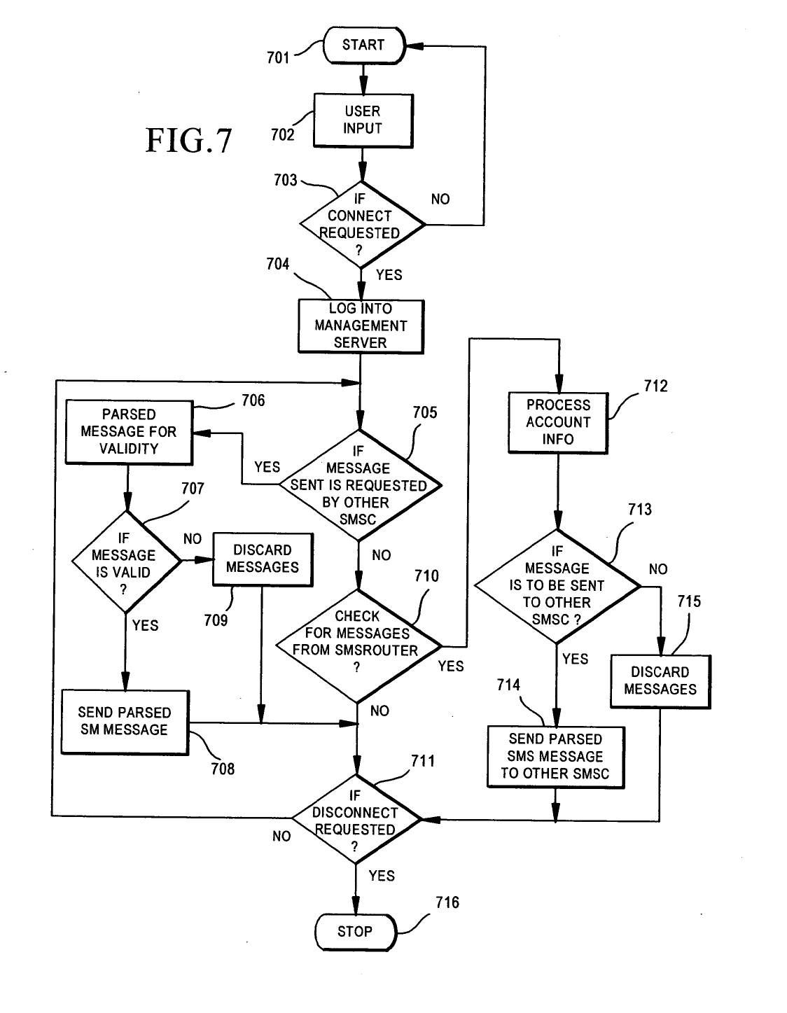

Another program that runs on the management server is the bridging program, shown in FIG. 7. The bridging program is not essential for the invention disclosed herein, but can be added to the system to allow the system to exchange SMS messages with the SMSC centers of wireless carriers. The bridging program checks messages, sent to it from the management server, to determine if the messages should be delivered to an external carrier. If the messages should be delivered to an external carrier, the bridging program connects to the carriers network via HyperText Transfer Protocol (http). Likewise, a message in the wireless carrier's network can be delivered to the system disclosed herein via http through the bridging program.

The bridging program can connect in a variety of ways with different protocols such as SMPP (Short Message Peer-to-Peer), which is a telecommunications standard. It can also interface with telephone companies using assigned e-mail addresses (for example: 16719881234@telco.com). The bridging program is referred to below as “SMSBridge,” and operates according to an event driven algorithm.

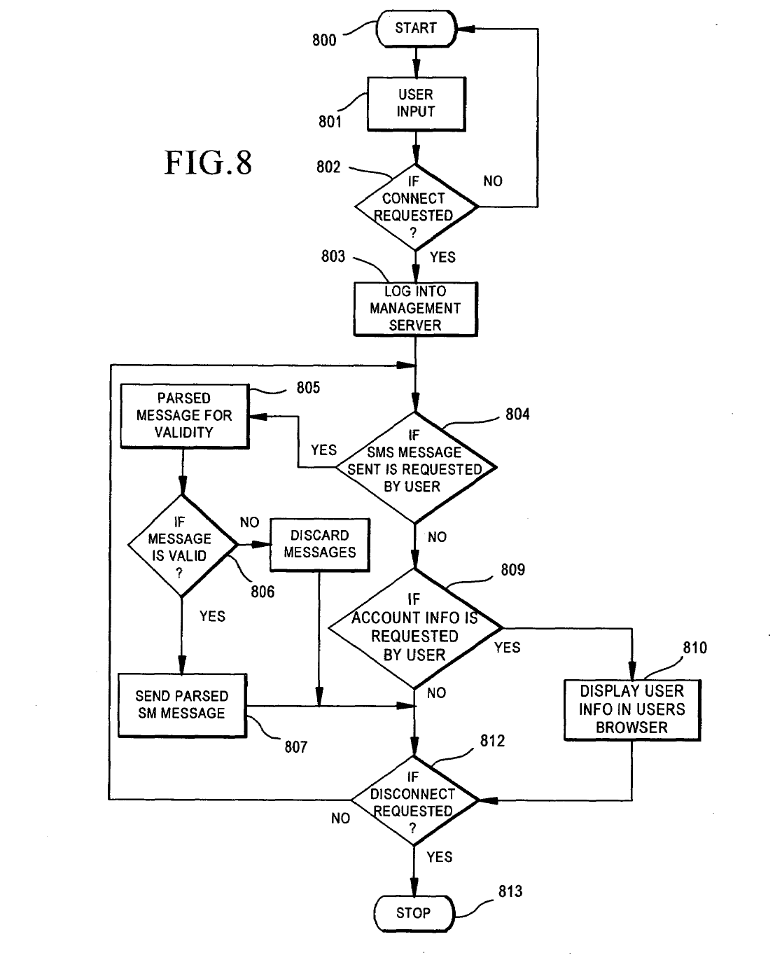

The “webserver” program allows a user to send messages to a recipient's cellular telephone and receive messages from a cellular telephone on the user's computer. This program communicates with the management server and allows users to send and receive SMS messages using an HTML based web interface. This program also allows a user to access his or her account information via the user's computer. To use this feature of the system, a user can log into the server using a standard web browser. Referring to FIG. 8, the webserver program operates according to the event driven algorithm shown in that figure.

The program that allows a user to send messages to a recipient's cellular telephone and receive messages from a cellular telephone via the user's email account is referred to below as the “mail gateway” program. This program communicates with the management server and allows users to send and receive SMS messages via an email account. To use this feature of the system a user can create a regular SMS message in the user's email program, and addresses the message to the desired recipient's telephone number at the management server's address, such as:
recipient'snumber@managementserver.com

The mail gateway program will receive the email, parse the email for the recipient's phone number and the sender's account information, and send the message to the management server for delivery.

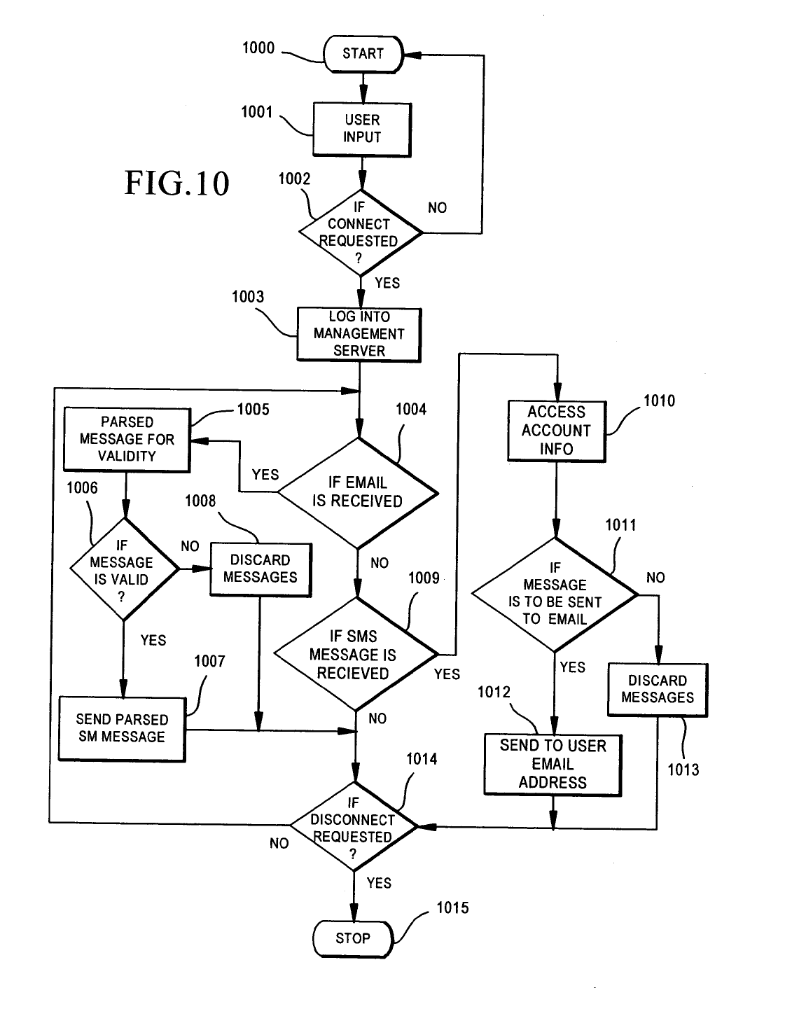

A user's account can also be set up to receive SMS messages via email. When an account has been set up to use this feature, the routing program will send the message to the mail gateway program for email delivery to a user's email address. Referring to FIG. 10, the mail gateway program operates according to an event driven algorithm.

It should be noted that the algorithms of the system disclosed herein, illustrated with the use of flow charts, are multithreaded event driven algorithms. Therefore, the system is capable of simultaneously sending and receiving a plurality of messages to support requests from one or more users.

According to the disclosure of this application, SMS messages can be sent to people in different cellular networks over the Internet. Using the system, messages can be sent to non-client cellular telephones from a client's telephone or personal computer. Messages can also be sent and received by clients on their cellular phones or personal computers. To send an SMS message over the system disclosed herein, a client enters the message on a user device. If the client is sending the message from a cell phone, the client connects with an SNB device in the network where the client is located and the SNB device forwards the message to the management server. If the client is sending the message from his or her computer, the client sends the message directly to the management server. The management server determines the route that the message must take to reach the intended recipient, and routes the message accordingly. If the recipient can only receive the message via cellular telephone the management server forwards the message to the SNB device in the recipient's network, and the SNB device forwards the message to the recipient. If the recipient can receive the message on his or her email program, the management server also forwards the device to the recipient's email. If the recipient can retrieve the message using an HTML based interface, the management server stores the message for retrieval.

Those who are skilled in this art will recognize that the system disclosed herein is comprised of a variety of physical components and these components can be programmed to operate according to event driven algorithms. It is to be understood, however, that the invention is not limited to the specific features shown or described, and that the means and construction shown or described comprise only the preferred forms of putting the invention into effect. Additionally, while this invention is described in terms of being used for sending SMS messages and text messages between wireless communication networks, it will be readily apparent to those skilled in the art that the invention can be adapted to other uses as well. Therefore, the invention should not be construed as being solely limited to use in SMS messaging, and is therefore, claimed in any of its forms or modifications within the legitimate and valid scope of the appended claims.

1. A system for sending and receiving SMS messages between cellular user devices located in different wireless networks without traversing a network bridge maintained by a Short Message Service Center, said system comprising:
a plurality of SMS Network Boundary (SNB) devices;
a server;
a plurality of cellular user devices;
each of said plurality of SNB devices further comprising a SNB cellular communications device configured to communicate within a wireless network and a SNB computer, said SNB cellular communications device and said SNB computer being configured to communicate SMS messages between said SNB cellular communications device and said SNB computer;
a first SNB device being registered to a first wireless network, and a second SNB device being registered to a second wireless network, said first and second wireless networks being different networks;
said server further comprising a computer having a machine readable storage, having stored thereon one or more computer programs comprising a plurality of code sections executable by a machine for maintaining a plurality of interrelated tables comprising a database, said database containing user-provided personalized information cross-referencing SMS user devices and predetermined routing and identification information for routing SMS messages to selected, identified SMS message recipients, said server being in communication with a plurality of SNB computers;
said server being configured to receive an SMS message from said first SNB device and to route and forward said SMS message to second SNB device;
said a plurality of cellular user devices comprising at least a first cellular user device being registered to said first wireless network and a second cellular user device being registered to said second wireless network;
whereby an SMS message initiated at said first cellular user device may be sent to said first SNB device via said first wireless network, and said first SNB device will forward said SMS message to said server, and said server will obtain routing information and forward said SMS message to said second SNB device, and said second SNB device will forward said SMS message to said second cellular user device via said second wireless network.

2. The system claimed in claim 1 wherein at least one of said SNB devices comprises a cellular telephone connected to said SNB computer.

3. The system claimed in claim 1 wherein an SNB computer corresponding to at least one of said plurality of SNB devices has a machine readable storage, having stored thereon one or more computer programs comprising a plurality of code sections executable by a machine for receiving SMS messages from said corresponding SNB device and formatting said SMS message for transmission to said server.

4. The system claimed in claim 3 wherein said server is in physical proximity to one of said SNB devices and sends SMS messages directly to and receives SMS messages directly from said SNB device without using the Internet.

5. The system claimed in claim 3 wherein said server is connected to said plurality of SNB devices via the internet.

6. The system claimed in claim 3 wherein at least one of said cellular user devices is configured to receive SMS messages as e-mail, and said server is configured to forward SMS messages to said cellular user device formatted as e-mail.

7. The system claimed in claim 3 wherein at least one of said cellular user devices is configured to receive SMS messages formatted as hyper text markup language (HTML), and said server is configured to forward SMS messages to said cellular user device formatted as HTML.

8. A system for sending and receiving SMS messages between a cellular user device located in a wireless network and a personal computer without traversing a network bridge maintained by a Short Message Service Center, said system comprising:
at least one SMS Network Boundary (SNB) device;
a server;
at least one cellular user device;
a personal computer
said SNB device further comprising an SNB cellular communications device registered to a cellular network and configured to communicate within a wireless network and a SNB computer, said SNB cellular communications device and said SNB computer being configured to communicate SMS messages between said SNB cellular communications device and said SNB computer;
said server further comprising a computer having a machine readable storage, having stored thereon one or more computer programs comprising a plurality of code sections executable by a machine for maintaining a plurality of interrelated tables comprising a database, said database containing user-provided personalized information cross-referencing SMS user devices and predetermined routing and identification information for routing SMS messages to selected, identified SMS message recipients, said server being in communication with a plurality of SNB devices and being connected to the Internet;
said personal computer being attached to the Internet and being configured to receive SMS messages from said server,
said server being configured to receive an SMS message from said SNB device and to route and forward said SMS message to said personal computer, and to receive an SMS message from said personal computer and route and forward said SMS message to said SNB device;
said cellular user device comprising a cellular user device registered to said wireless network;
whereby an SMS message initiated at said cellular user device may be sent to said SNB device via said cellular network, and said SNB device may forward said SMS message to said server, and said server will obtain routing information and forward said SMS message to said personal computer.

9. A system as claimed in claim 8 wherein said cellular user device and said personal computer are configured to receive SMS messages as e-mail, and said server is configured to receive and forward SMS messages as e-mail.

10. A system as claimed in claim 8 wherein said cellular user device and said personal computer are configured to receive SMS messages as hyper text markup language (HTML), and said server is configured to receive and forward SMS messages as HTML.

11. A system for routing SMS messages from a sender cellular user device to a receiver cellular user device and to route a reply SMS message from said receiver cellular user device to said sender cellular user device comprising:
establishing a database comprising records containing information regarding a potential SMS message recipient, including said SMS message recipient's wireless network and telephone number and identifying information;
establishing a registered user's account including said registered user's billing information, wireless network and telephone number, and references to identifying information of potential recipients of SMS messages sent by said registered user;
receiving an SMS message from said registered user, said SMS message including information sufficient to identify said registered user, said registered user's intended SMS message recipient;
accessing said registered user's account to obtain said recipient's wireless network and telephone number;
identifying an SNB device in said recipient's wireless network;
forwarding said SMS message to said SMS message recipient via said identified SMB device;
creating an entry in said database associating said SMS message recipient's wireless network, telephone number, and identified SNB device with said registered user such that a reply from said recipient's telephone number may be cross referenced to said recipient's SNB device to obtain routing information to route SMS messages to said registered user,
receiving a reply from said SMS message recipient intended for said registered user;
searching said database to locate routing information for routing said reply to said registered user,
sending said reply to said registered user.

12. A system for routing SMS messages from a registered user's personal computer to a receiver cellular user device and to route a reply SMS message from said receiver cellular user device to said registered user's personal computer comprising:
establishing a database comprising records containing information regarding a potential SMS message recipient, including said SMS message recipient's wireless network and telephone number and identifying information;
establishing a registered user's account including said registered user's billing information, IP address for said registered user's personal computer, and references to identifying information of potential recipients of SMS messages sent by said registered user;
receiving an SMS message from said registered user, said SMS message including information sufficient to identify said registered user, said registered user's intended SMS message recipient;
accessing said registered user's account to obtain said recipient's wireless network and telephone number;
identifying an SNB device in said recipient's wireless network;
forwarding said SMS message to said SMS message recipient via said identified SMB device;
creating an entry in said database associating said SMS message recipient's wireless network, telephone number, and identified SNB device with said registered user such that a reply from said recipient's telephone number may be cross referenced to said recipient's SNB device to obtain routing information to route SMS messages to said registered user,
receiving a reply from said SMS message recipient intended for said registered user;
searching said database to locate routing information for routing said reply to said registered user,
sending said reply to said registered user.
